(19) United States
(12) Patent Application Publication
(10) Pub. No.: US 2025/0225620 A1
(43) Pub. Date: Jul. 10, 2025

(54) SPECIAL EFFECT IMAGE PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Yuanhuang ZHANG, Beijing (CN)

(21) Appl. No.: 18/849,961

(22) PCT Filed: Mar. 6, 2023
(86) PCT No.: PCT/CN2023/079812

§ 371 Date: Sep. 23, 2024

(30) Foreign Application Priority Data
Mar. 25, 2022 (CN) 202210307721.1

(51) Int. Cl. G06T 5/50; G06T 7/12; G06T 7/50

(52) U.S. Cl. CPC G06T 5/50; G06T 7/12; G06T 7/50; G06T 2207/20221

(57) ABSTRACT

The present disclosure provides an effect image processing method and apparatus, an electronic device, and a storage medium. The method includes: determining a to-be-processed effect fusion model according to an effect attribute of a target effect to be overlaid; in response to receiving a target effect display instruction, determining a target effect fusion model according to the to-be-processed effect fusion model and a human body segmentation region in a to-be-processed image corresponding to a target object; and writing pixel depth information corresponding to the target effect fusion model into a rendering engine, to enable the rendering engine to render a target image corresponding to the to-be-processed image based on the pixel depth information, in which the target image includes the target effect.

The present application claims the priority to Chinese Patent Application No. 202210307721.1, submitted to the China National Intellectual Property Administration on Mar. 25, 2022, the entire disclosure of which is incorporated herein by reference as portion of the present application.

### TECHNICAL FIELD

The present disclosure relates to the technical field of image processing, for example, to an effect image processing method and apparatus, an electronic device, and a storage medium.

### BACKGROUND

With the continuous development of image processing technology, effects (special effects) provided by the application software to the user are also more and more rich. For example, after the user captures an image with a terminal device, the user can obtain a corresponding effect image by processing the image based on the functions built in the application.

However, in the solution provided by the related art, when the effect provided by the application is added to some specific regions (e.g., some regions of the human body) within the image, there may be a case where the effect cannot be accurately matched with the picture of the region, and the image processing effect is to be improved; furthermore, the phenomenon of clipping between the effect and the content of the frame may also occur, which causes the final effect image to be less realistic and the user to experience poor use of the effects.

### SUMMARY

The present disclosure provides an effect image processing method and apparatus, an electronic device, and a storage medium, which improves the accuracy of fusing an effect with a specific region in an image, enables the finally obtained effect image to be more realistic, and enhances the user's use experience.

In a first aspect, the present disclosure provides an effect image processing method, including:
determining a to-be-processed effect fusion model according to an effect attribute of a target effect to be overlaid;
in response to receiving a target effect display instruction, determining a target effect fusion model according to the to-be-processed effect fusion model and a human body segmentation region in a to-be-processed image corresponding to a target object; and
writing pixel depth information corresponding to the target effect fusion model into a rendering engine, to enable the rendering engine to render a target image corresponding to the to-be-processed image based on the pixel depth information, in which the target image includes the target effect.

In a second aspect, the present disclosure further provides an effect image processing apparatus, including:
a to-be-processed effect fusion model determination module, configured to determine a to-be-processed effect fusion model according to an effect attribute of a target effect to be overlaid;
a target effect fusion model determination module, configured to, in response to receiving a target effect display instruction, determine a target effect fusion model according to the to-be-processed effect fusion model and a human body segmentation region in a to-be-processed image corresponding to a target object; and
a rendering module, configured to write pixel depth information corresponding to the target effect fusion model into a rendering engine, to enable the rendering engine to render a target image corresponding to the to-be-processed image based on the pixel depth information, in which the target image includes the target effect.

In a third aspect, the present disclosure further provides an electronic device, including:
at least one processor; and
a storage apparatus, configured to store at least one program,
in which the at least one program, when executed by the at least one processor, enables the at least one processor to implement the effect image processing method mentioned above.

In a fourth aspect, the present disclosure further provides a storage medium including computer-executable instructions, and the computer-executable instructions, when executed by a computer processor, are configured to perform the effect image processing method mentioned above.

In a fifth aspect, the present disclosure further provides a computer program product including a computer program carried on a non-transitory computer-readable medium, and the computer program includes program code for performing the effect image processing method mentioned above.

### BRIEF DESCRIPTION OF DRAWINGS

FIG. 1 is a schematic flowchart of an effect image processing method provided by at least one embodiment of the present disclosure;

FIG. 2 is a schematic diagram of a to-be-processed effect fusion model provided by at least one embodiment of the present disclosure;

FIG. 3 is a schematic diagram illustrating a target reference axis controlling a human body segmentation region and a to-be-processed effect fusion model to move together provided by at least one embodiment of the present disclosure;

FIG. 4 is a schematic structural diagram of an effect image processing apparatus provided by at least one embodiment of the present disclosure; and

FIG. 5 is a schematic structural diagram of an electronic device provided by at least one embodiment of the present disclosure.

### DETAILED DESCRIPTION

Embodiments of the present disclosure will be described below with reference to the drawings. Although the drawings illustrate some embodiments of the present disclosure, the present disclosure may be implemented in various forms, and these embodiments are provided to facilitate understanding of the present disclosure. The drawings and embodiments of the present disclosure are for illustrative purposes only.

The various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units. The modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

Before introducing the technical solutions in the present disclosure, the application scenario of the embodiments of the present disclosure may be exemplarily explained first. For example, when a user captures an image using a camera device on a mobile terminal, the image may be imported into an application, and effects may be added to the image based on functions built into the application. In this case, it may occur that the added effects do not match exactly with the content of the frame; furthermore, if some dynamic models are preset in the effects, these dynamic models may also experience clipping with the content of frame, resulting in poor quality of the processed effect image. In this case, according to the technical solution of the present embodiment, a to-be-processed effect fusion model is determined in advance, and a human body segmentation region in the frame is determined; the to-be-processed effect fusion model and the human body segmentation region are fused to obtain a target effect fusion model; finally, the depth information of the corresponding pixels of the target effect fusion model is written into a rendering engine to obtain a target image, thereby effectively preventing the occurrence of the effect not matching the content of frame accurately and being prone to clipping.

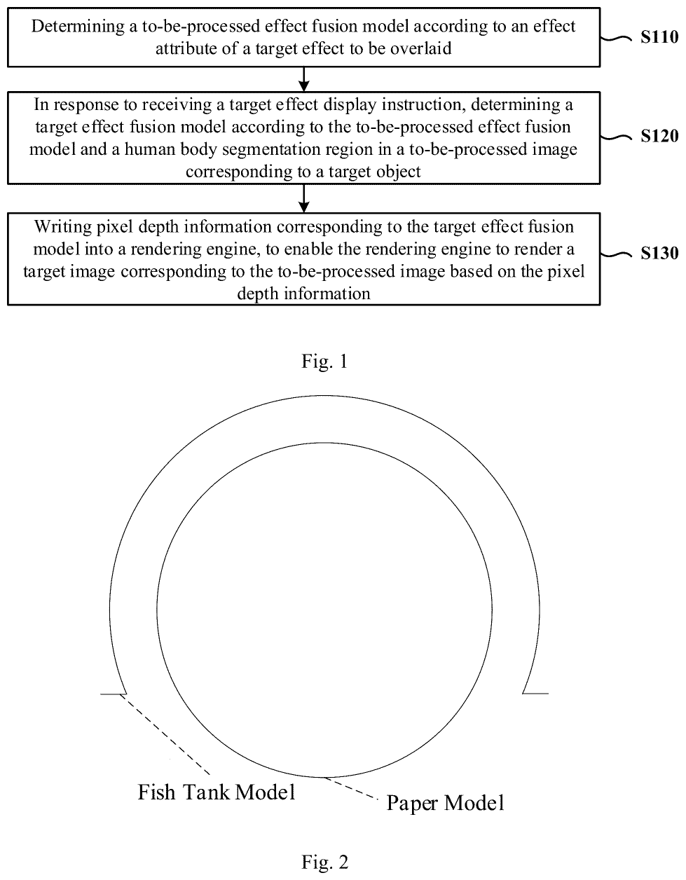

FIG. 1 is a schematic flowchart of an effect image processing method provided by at least one embodiment of the present disclosure, and the embodiment of the present disclosure is applicable to a case where effects are matched with an image with high accuracy to obtain an effect image; the method may be performed by an effect image processing apparatus, which may be implemented in the form of software and/or hardware, for example, by an electronic device, and the electronic device may be a mobile terminal, a Personal Computer (PC) terminal, a server, or the like.

As shown in FIG. 1, the method includes:

S110, determining a to-be-processed effect fusion model according to an effect attribute of a target effect to be overlaid.

The apparatus for performing the effect image processing method provided by the embodiments of the present disclosure may be integrated in an application software supporting the effect image processing function, and the software may be installed in an electronic device, which may be a mobile terminal or a PC terminal, or the like. The application software may be a kind of software for image/video processing, and the application software will not be described in detail here as long as the image/video processing can be implemented. The application software may also be a specially developed application program to implement the software for adding and presenting effects, or may be integrated in a corresponding page, and the user may implement the processing of effect video through the integrated page in the PC terminal.

The technical solution of the present embodiment may be performed based on existing images (i.e., images actively imported into the application by the user) as the data basis, or may also be performed based on the images captured by the user in real time. That is, when a to-be-processed image and a target effect selected by the user in the application are determined, the target effect can be fused with the to-be-processed image based on the solution of the present embodiment, thereby obtaining an effect image desired by the user.

In this embodiment, the target effect to be overlaid may be an effect that is pre-developed and integrated into the application, for example, the target effect may be a dynamic fish tank effect that may be added to the image, within which there are also a plurality of dynamic goldfish models. The thumbnail corresponding to the target effect may be associated with a pre-developed control that, when detected by a user triggering the control, indicates that the user wishes to add the effect to the image. In this case, the application needs to retrieve the data associated with the effect and fuse the effect with the corresponding frame in the image according to the solution of the present embodiment, thereby obtaining the target image containing the effect. Taking the above-mentioned fish tank image as an example, in the obtained effect image, the fish tank is fused with the user's head region, thus presenting a visually amusing effect of the user's head being encased in a fish tank. Additionally, several goldfish will be displayed near the user's head inside the fish tank.

It will be understood by those skilled in the art that in practical applications, the target effect may be fused with either one image or multiple frames of video frames, in which case the finally obtained multiple effect images may present dynamic visual effects. Furthermore, the pattern of the target effect is not limited to the fish tank in the above example, but may be a variety of interesting skeuomorphic effects, such as a floating balloon, and the like, and the embodiments of the present disclosure are not limited herein.

In the present embodiment, when a user selects a corresponding target effect for an image, a corresponding to-be-processed effect fusion model is first determined according to the effect attribute of the effect. For example, the to-be-processed effect fusion model may be a pre-developed three-dimensional model, and after the to-be-processed effect fusion model has been developed, the to-be-processed effect fusion model needs to be associated with the target effect, so that the model is retrieved based on the application software and fused with a specific region in the frame in response to detecting that the user triggers a control associated with the target effect. Taking the above-mentioned fish tank effect as an example, the to-be-processed effect fusion model may be a fish tank model pre-developed in a three-dimensional space; furthermore, the model is also associated with a plurality of goldfish-style sub-models, and when it is detected that the user triggers the control corresponding to the fish tank effect, the application may call the above-mentioned model and execute the subsequent processing scheme.

Accordingly, the effect attribute may include parameters that determine the effect display shape and effect display area of the target effect, as well as the parameter that determine the style of the to-be-processed effect fusion model, and directly determine the visual effect of the finally obtained effect image. An effect fusion model corresponding to the target effect is determined as the to-be-processed effect fusion model, according to the effect display shape of the target effect and the effect display area of the target effect.

The effect fusion model is a pre-developed model associated with the target effect and is a to-be-processed effect fusion model, the display shape is information that determines the shape of the model, and the display area is information that determines which part of the region of the frame the model is fused with.

Continuing with the above example, in response to the target effect being a fish tank effect, the application may determine that the display shape of the effect is an ellipse and determine that the display area of the fish tank model is the region of the head of the user. On the basis of this, the application may retrieve the pre-developed fish tank model as the to-be-processed effect fusion model, and the fish tank model needs to be fused with a frame corresponding to the head of the user in a subsequent process, so that the finally obtained effect image may present a visual effect of the user's head being encased in an elliptical fish tank.

It should be understood by those skilled in the art that the effect display shape and the effect display area of the target effect may be various in the actual application process, the effect display shape may be a triangle, a rectangle, etc. in addition to the ellipse in the above example, and accordingly, the display area may be an area of the user's arm or the user's body, etc., and the embodiments of the present disclosure are not limited herein.

S120, in response to receiving a target effect display instruction, determining a target effect fusion model according to the to-be-processed effect fusion model and a human body segmentation region in a to-be-processed image corresponding to a target object.

The target effect display instruction may be an instruction generated based on a user's triggering operation, or may be an instruction automatically generated in response to detecting that the image frame satisfies a preset condition. Illustratively, the effect image processing control may be pre-developed in the application, and in response to detecting the user's triggering operation on the control, the application may invoke a pre-written program and perform the effect image processing operation; alternatively, the target effect display instruction is automatically generated in response to detecting a frame including the user's body in the display interface, and the application may perform the effect image processing operation in response to receiving the instruction.

In the present embodiment, in response to receiving the target effect display instruction, the to-be-processed effect fusion model may also be displayed. The application may transparently display the paper model in the to-be-processed effect fusion model according to the target effect display instruction.

In the present embodiment, the to-be-processed effect fusion model may be composed of a plurality of parts, for example, a paper model may be included in the to-be-processed effect fusion model, and the paper model may be a part that needs to correspond to a specific region in the frame; furthermore, the model may be pre-constructed by a worker based on an associated image processing application (e.g., non-linear effect production software), and when the user triggers a fish tank effect, the application may retrieve the pre-constructed paper model, write depth information of the image captured by the user to the paper model, and finally render the paper model onto the corresponding display interface. In the present embodiment, when the captured image is presented based on the paper model, it is possible to shield other models (e.g., goldfish) involved in the fish tank effect, and avoiding the problem of “clipping” that often occurs when modeling the captured image separately, where other models may interfere with it.

Taking FIG. 2 as an example, for a fish tank effect, a circular paper model may be pre-constructed in a three-dimensional space for the effect, and the paper model needs to be fused with the frame of the head region of the user in the subsequent process; and a fish tank model surrounding the paper model is created outside the paper model, and the relative position of the paper model and the fish tank model are fixed and associated with the target effect. Based on this, in response to the control corresponding to the target effect being detected to be triggered, the application is caused to invoke and display the paper model and the fish tank model. In practice, in order to make the finally obtained effect image more realistic, it is necessary to set parameters, such as transparency etc., for the paper model of the fish tank effect, so that the effect fusion model corresponding to the fish tank effect shows only the fish tank model outside the paper model when displayed on the display interface, and hides the paper model corresponding to the frame of the head region of the user, thereby avoiding the influence of the paper model on the effect image.

In the present embodiment, the paper model is provided in the to-be-processed effect image in an advantage of facilitating the use of locating and corresponding effects to specific regions in the frame during the process of generating the effect image, thereby avoiding the problem of poor matching of the effects with the frame; furthermore, after adopting the paper model, it is not necessary to construct a three-dimensional (3D) model for a region corresponding to the paper model during the process of generating the effect image, indirectly improving the effect image processing capability of the application.

In the present embodiment, in response to receiving the target effect display instruction, the application needs to determine the human body segmentation region in the to-be-processed image corresponding to the target object; and the human body segmentation region is then bound with the to-be-processed effect fusion model to obtain the target effect fusion model.

The to-be-processed image may be an image captured in real time by a user through a camera device on a mobile terminal, or may be an image actively uploaded into an application, and a part or all of a user's body may be included in the to-be-processed image after the user is predetermined as a target object. In practical application, the target object may be one or more specific users or any user, and in the second case, when a user's body is detected in the frame, the user is determined as the target user.

Accordingly, the human body segmentation region of the target object is any area of the torso segmentation region, for example, a region corresponding to the head of the target user, a region corresponding to the arm of the target user in the displayed frame, and the like. In practical application, one or more human body segmentation regions may be determined according to requirements, for example, only the region corresponding to the user's head is taken as the human body segmentation region, or all of the region corresponding to the user's head, the region corresponding to the user's arm, and the region corresponding to the user's leg are taken as the human body segmentation region, and the embodiments of the present disclosure are not limited herein.

During the process of determining the human body segmentation model, the human body segmentation region in the to-be-processed image may be determined based on a human body segmentation algorithm or a human body segmentation model. For example, the human body segmentation algorithm or the human body segmentation model may be a pre-trained neural network model integrated into an application for segmenting at least a frame corresponding to a user's body in a to-be-processed image to determine a human body segmentation region in the to-be-processed image. The input of the above-mentioned model is a to-be-processed image including a part or all of the frame of the user's body, and the output is a human body segmentation region corresponding to the to-be-processed image. It should be understood by those skilled in the art that the human body segmentation algorithm or the human body segmentation model may be trained based on the respective training set and the validation set before it is integrated into the application, and when the loss function of the algorithm or the model converges, it indicates that the model training is complete and can be deployed in the application. The training process is not described in detail in the present embodiment.

If the application determines the human body segmentation region of the target object in the to-be-processed image, the region is bound with the to-be-processed effect fusion model, thereby obtaining the target effect fusion model. The human body segmentation region is bound with the to-be-processed effect fusion model to obtain a to-be-used effect fusion model; and intersection processing is performed on the human body segmentation region and the to-be-used effect fusion model to determine the target effect fusion model.

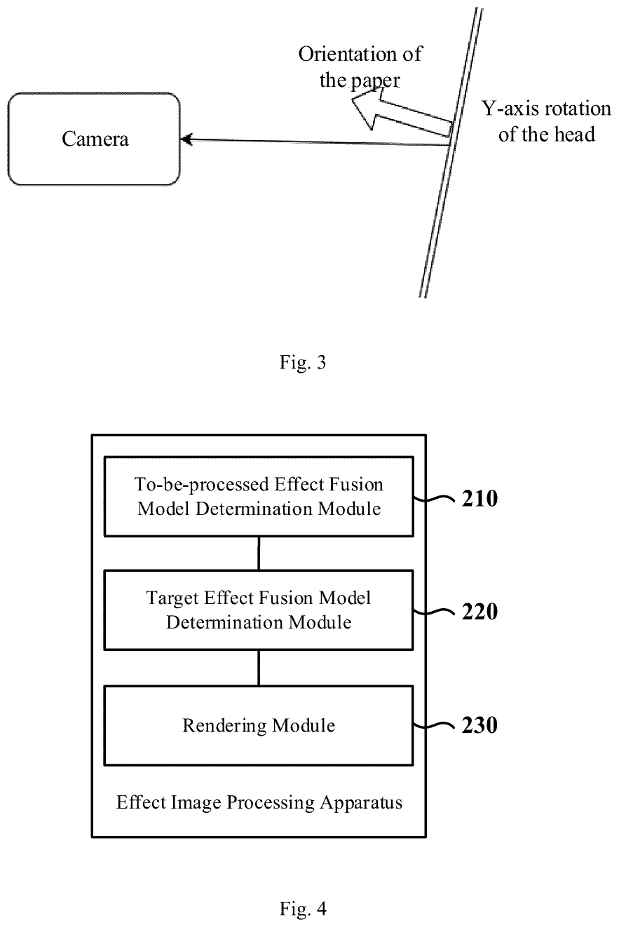

During the process of determining the to-be-used effect fusion model, a target reference axis corresponding to the target object may be first determined; and the target reference axis is used to control the human body segmentation region and the to-be-processed effect fusion model to move together, to obtain the to-be-used effect fusion model. For example, the target reference axis of the target object may be one axis corresponding to the user's body within the pre-constructed three-dimensional spatial coordinate system. Taking FIG. 3 as an example, after an application constructs a three-dimensional space coordinate system based on a frame on a display interface, the y-axis of the coordinate system corresponding to the user's head region may be served as the target reference axis. On this basis, when the user's head on the display interface tilts, the y-axis in the three-dimensional space will also undergo adaptive changes.

Intersection processing is performed on the human body segmentation region and the to-be-used effect fusion model. Firstly, a region corresponding to the to-be-used effect fusion model is determined, then a common region between the region and the human body segmentation region is determined, thereby associating the data corresponding to the two regions. In practical application, the above-mentioned processing procedure is a process of associating the frame of the user's head region with the to-be-used effect fusion model. By associating the y-axis with the to-be-processed effect fusion model, the binding of the human body segmentation region and the to-be-processed effect fusion model can be achieved. On the basis of this, if the user's head rotates, that is, if the human body segmentation region undergoes changes in position or orientation, the target reference axis can control the to-be-processed effect fusion model and human body segmentation region to move together. Continuing with the example of FIG. 3, if the display interface presents a frame where the user is looking up, that is, if the user's head region undergoes changes in position and orientation, the y-axis in the three-dimensional space will also adaptively change with the change of this region. Simultaneously, the y-axis will drive the position and orientation of the to-be-processed effect fusion model to change, that is, to adjust the position of the paper model in the to-be-processed effect fusion model to face a virtual camera. This allows for the linkage between the model and the human body segmentation region when the application processes a plurality of effect images.

In the present embodiment, the binding of the human body segmentation region with the to-be-processed effect fusion model with the target reference axis as an intermediate association portion is advantageous in that when the application continuously processes a plurality of images and generates corresponding target images, the effect finally presented in the plurality of images is constantly made to move following the movement of the specific portion on the user's body, thereby presenting more excellent dynamic visual effect.

After obtaining the to-be-used effect fusion model, the intersection processing may be performed on the human body segmentation region the to-be-used special-effect fusion model in a fragment shader, thereby obtaining the target effect fusion model. Here, the fragment shader is a programmable program for image processing running on hardware with a programmable rendering pipeline. In the present embodiment, after the human body segmentation region and the to-be-used effect fusion model are determined, the corresponding fragment shader may be run to fuse the human body segmentation region and the to-be-used effect fusion model.

For example, if the human body segmentation region is determined to be the region corresponding to the user's head and the to-be-used effect fusion model is the model corresponding to the fish tank effect (i.e., the model includes both an elliptical fish tank model and a transparent paper model), the application may run the fragment shader to extract a frame corresponding to the user's head region and combine the frame with the to-be-used effect fusion model to obtain the target effect fusion model, and the target effect fusion model may be rendered in the display interface to present a frame of the user's head being in the fish tank.

It may be determined, based on the above description, that the process of generating the target effect fusion model may also be a process of matting sampling a frame of the human body segmentation region, and combining the matting result with the to-be-used effect fusion model, thereby obtaining an image to be rendered on the display interface.

S130, writing pixel depth information corresponding to the target effect fusion model into a rendering engine, to enable the rendering engine to render a target image corresponding to the to-be-processed image based on the pixel depth information.

The rendering engine may be a program that controls a Graphics Processing Unit (GPU) to render an associated image. In the present embodiment, after the target effect fusion model is determined, under the drive of the rendering engine, the computer can complete the task of drawing the image reflected by the target effect fusion model onto a target display interface. Accordingly, the rendered target image includes at least the target effect. Continuing with the above example, after the target effect fusion model corresponding to the fish tank effect is determined, under the drive of the rendering engine, after rendering the model and presenting the obtained target image on the display interface, an image may be presented in which the user's head is inside the fish tank.

Pixel depth information of a plurality of pixels corresponding to the target effect fusion model is determined based on a rendering camera, and the pixel depth information is written into the rendering engine, to obtain the target image based on the rendering engine writing the pixel depth information into the paper model.

The rendering camera may be a program for determining parameters associated with each pixel in a 3D virtual space, and the pixel depth information may be a corresponding depth value of each pixel in the finally presented frame. It should be understood by those skilled in the art that the depth value of each pixel is used at least to reflect the depth of the pixel in the image in the frame (i.e., the distance between the virtual rendering camera lens and the pixel); furthermore, the depth value may also determine the distance between its corresponding pixel and the viewpoint in the pre-constructed three-dimensional space.

For example, if the target effect is the fish tank effect and after the target effect fusion model corresponding to the effect is determined, the application needs to first acquire depth values of a plurality of pixels on the head frame of the user using the rendering camera; the depth values of the plurality of pixels are written into the rendering engine, so that the rendering engine may write the depth values to the paper model corresponding to the user's head region according to a relative positional relationship; and finally, the paper model is rendered to obtain the target image, in which not only a frame of the fish tank as an effect is included but also a frame of the user's head is presented.

In practical application, a rendering engine related parameter (for example, color write mask) may be set to 0, i.e., during the process of rendering to obtain the target image, only depth values of a plurality of pixels are written into the paper model without writing color information of the plurality of pixels into the paper model. On this basis, if the target effect is the fish tank effect including a plurality of goldfish sub-models in the above example, in the finally obtained frame by rendering, the frame of the user's head may serve to shield the goldfish frame, preventing the goldfish frame from clipping the user's head.

In practical application, in response to the target effect display instruction being not received again and the to-be-processed image being acquired again, the target effect fusion model is determined based on binding of the to-be-processed effect fusion model with the human body segmentation region.

In the process of determining the target effect fusion model and rendering the corresponding target image on the display interface, the application may also store the information determined in the above process and the binding relationship between the to-be-processed effect fusion model and the human body segmentation region of the target object, thereby directly invoking the above data and rendering the corresponding frame on the target display interface in response to the image containing the human body segmentation region of the target object being acquired again. Continuing with the above example, for the fish tank model, the application may store the binding relationship between the frame of the target user's head region and the to-be-processed effect fusion model, and the target effect fusion model reflecting the frame of the user's head being encased in the fish tank; and if the frame of the target user's head region is detected again in the image captured by the user or the image actively uploaded by the user, the application may directly retrieve the corresponding target effect fusion model, thereby rendering the frame reflected by the model onto the display interface based on the rendering engine.

By storing the binding relationship between the to-be-processed effect fusion model and the human body segmentation region and the corresponding target effect fusion model, the application can directly invoke relevant data for rendering in response to the to-be-processed image being acquired again and the human body segmentation region of the target object being detected therefrom, thereby avoiding waste of computing resources and improving the effect image processing efficiency of the application.

In the technical solutions of the embodiments of the present disclosure, the to-be-processed effect fusion model is determined according to the effect attribute of the target effect to be overlaid, that is, the to-be-processed effect fusion model corresponding to a specific region in an image is determined; in response to receiving the target effect display instruction, the target effect fusion model is determined according to the to-be-processed effect fusion model and the human body segmentation region in the to-be-processed image corresponding to the target object, thereby achieving the fusion of the effect with frame content of the region; and the pixel depth information corresponding to the target effect fusion model is written into the rendering engine, to enable the rendering engine to render the target image corresponding to the to-be-processed image based on the pixel depth information. In this way, the accuracy of fusing the effect with the specific region in the image is improved; furthermore, the occurrence of clipping between the effect and the content of the frame is avoided, so that the finally obtained effect image is more realistic, and the user's experience is enhanced.

FIG. 4 is a schematic structural diagram of an effect image processing apparatus provided by at least one embodiment of the present disclosure, and as shown in FIG. 4, the apparatus includes a to-be-processed effect fusion model determination module 210, a target effect fusion model determination module 220, and a rendering module 230.

The to-be-processed effect fusion model determination module 210 is configured to determine a to-be-processed effect fusion model according to an effect attribute of a target effect to be overlaid.

The target effect fusion model determination module 220 is configured to, in response to receiving a target effect display instruction, determine a target effect fusion model according to the to-be-processed effect fusion model and a human body segmentation region in a to-be-processed image corresponding to a target object.

The rendering module 230 is configured to write pixel depth information corresponding to the target effect fusion model into a rendering engine, to enable the rendering engine to render a target image corresponding to the to-be-processed image based on the pixel depth information; and the target image includes the target effect.

The to-be-processed effect fusion model determination module 210 is configured to determine an effect fusion model corresponding to the target effect as the to-be-processed effect fusion model, according to an effect display shape of the target effect and an effect display area of the target effect.

On the basis of the above technical solution, the effects image processing apparatus further includes a to-be-processed effect fusion model display module.

The to-be-processed effect fusion model display module is configured to display the to-be-processed effect fusion model in response to receiving the target effect display instruction; and a paper model in the to-be-processed effect fusion model is displayed transparently.

On the basis of the above technical solution, the target effect fusion model determination module 220 includes a human body segmentation region determination unit and a target effect fusion model determination unit.

The human body segmentation region determination unit is configured to determine the human body segmentation region in the to-be-processed image corresponding to the target object.

The target specific fusion model determination unit is configured to bind the human body segmentation region with the to-be-processed effect fusion model to obtain the target effect fusion model.

The human body segmentation region determination unit is further configured to determine the human body segmentation region in the to-be-processed image based on a human body segmentation algorithm or a human body segmentation model.

On the basis of the above technical solution, the human body segmentation region is any area in a torso segmentation region.

The target specific fusion model determination unit is further configured to: bind the human body segmentation region with the to-be-processed effect fusion model to obtain a to-be-used effect fusion model; and perform intersection processing on the human body segmentation region and the to-be-used effect fusion model to determine the target effect fusion model.

The target specific fusion model determination unit is further configured to: determine a target reference axis corresponding to the target object; and use the target reference axis to control the human body segmentation region and the to-be-processed effect fusion model to move together, to obtain the to-be-used effect fusion model.

The rendering module 230 is further configured to: determine, based on a rendering camera, pixel depth information of a plurality of pixels corresponding to the target effect fusion model; and write, based on the rendering engine, the pixel depth information into the rendering engine, to write the pixel depth information into a paper model in the to-be-processed effect fusion model to obtain the target image.

The target effect fusion model determination module 220 is further configured to, in response to the target effect display instruction being not received again and the to-be-processed image being acquired again, determine the target effect fusion model based on binding of the to-be-processed effect fusion model with the human body segmentation region.

In the technical solutions of the embodiments of the present disclosure, the to-be-processed effect fusion model is determined according to the effect attribute of the target effect to be overlaid, that is, the to-be-processed effect fusion model corresponding to a specific region in an image is determined; in response to receiving the target effect display instruction, the target effect fusion model is determined according to the to-be-processed effect fusion model and the human body segmentation region in the to-be-processed image corresponding to the target object, thereby achieving the fusion of the effect with frame content of the region; and the pixel depth information corresponding to the target effect fusion model is written into the rendering engine, to enable the rendering engine to render the target image corresponding to the to-be-processed image based on the pixel depth information. In this way, the accuracy of fusing the effect with the specific region in the image is improved; furthermore, the occurrence of clipping between the effect and the content of the frame is avoided, so that the finally obtained effect image is more realistic, and the user's experience is enhanced.

The effect image processing apparatus provided by the embodiments of the present disclosure can execute the effect image processing method provided by any of the embodiments of the present disclosure, and have functional modules and effects corresponding to the execution method.

The plurality of units and modules included in the above apparatus are divided only according to functional logic, but are not limited to the above division as long as corresponding functions can be realized. In addition, the names of the plurality of functional units are also merely for convenience of distinguishing from each other, and are not used to limit the protection scope of the embodiments of the present disclosure.

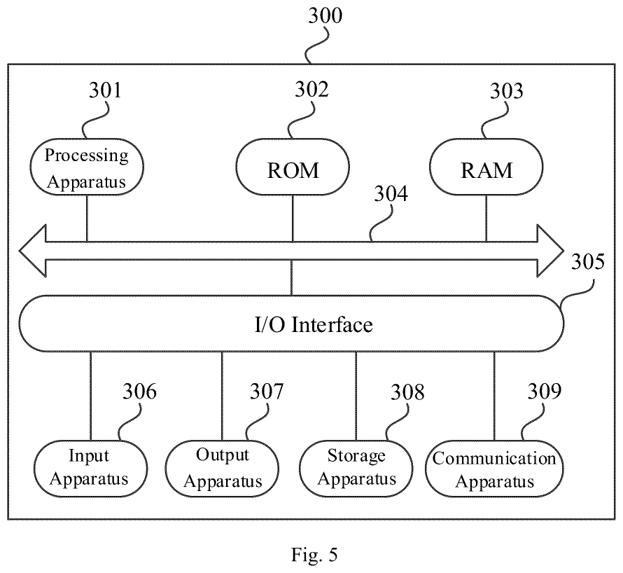

FIG. 5 is a schematic structural diagram of an electronic device provided by at least one embodiment of the present disclosure. Referring to FIG. 5, FIG. 5 illustrates a schematic structural diagram of an electronic device 300 suitable for implementing the embodiments of the present disclosure. The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), and fixed terminals such as a digital TV, a desktop computer, or the like. The electronic device 300 illustrated in FIG. 5 is merely an example, and should not pose any limitation to the functions and the range of use of the embodiments of the present disclosure.

As illustrated in FIG. 5, the electronic device 300 may include a processing apparatus 301 (e.g., a central processing unit, a graphics processing unit, etc.), which can perform various suitable actions and processing according to a program stored in a read-only memory (ROM) 302 or a program loaded from a storage apparatus 308 into a random-access memory (RAM) 303. The RAM 303 further stores various programs and data required for operations of the electronic device 300. The processing apparatus 301, the ROM 302, and the RAM 303 are interconnected through a bus 304. An input/output (I/O) interface 305 is also connected to the bus 304.

Usually, the following apparatuses may be connected to the I/O interface 305: an input apparatus 306 including, for example, a touch screen, a touch pad, a keyboard, a mouse, a camera, a microphone, an accelerometer, a gyroscope, or the like; an output apparatus 307 including, for example, a liquid crystal display (LCD), a loudspeaker, a vibrator, or the like; a storage apparatus 308 including, for example, a magnetic tape, a hard disk, or the like; and a communication apparatus 309. The communication apparatus 309 may allow the electronic device 300 to be in wireless or wired communication with other devices to exchange data. While FIG. 5 illustrates the electronic device 300 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 309 and installed, or may be installed from the storage apparatus 308, or may be installed from the ROM 302. When the computer program is executed by the processing apparatus 301, the above-mentioned functions defined in the methods of some embodiments of the present disclosure are performed.

The names of messages or information interacted between devices in an implementation of the present disclosure are for illustrative purposes only and are not intended to limit the scope of such messages or information.

The electronic device provided by the embodiment of the present disclosure belongs to the same concept as the effect image processing method provided by the above embodiment, technical details that are not elaborately described in the present embodiment may be referred to the above embodiment, and the present embodiment has the same effects as the above embodiment.

The embodiments of the present disclosure further provide a computer storage medium, which stores a computer program, and the computer program, when executed by a processor, implements the effect image processing method provided by the above-mentioned embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to:
determine a to-be-processed effect fusion model according to an effect attribute of a target effect to be overlaid; in response to receiving a target effect display instruction, determine a target effect fusion model according to the to-be-processed effect fusion model and a human body segmentation region in a to-be-processed image corresponding to a target object; and write pixel depth information corresponding to the target effect fusion model into a rendering engine, to enable the rendering engine to render a target image corresponding to the to-be-processed image based on the pixel depth information, in which the target image includes the target effect.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances; for example, the first acquisition unit may also be described as “a unit for acquiring at least two Internet Protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides an effect image processing method, and the method includes:
determining a to-be-processed effect fusion model according to an effect attribute of a target effect to be overlaid;
in response to receiving a target effect display instruction, determining a target effect fusion model according to the to-be-processed effect fusion model and a human body segmentation region in a to-be-processed image corresponding to a target object; and
writing pixel depth information corresponding to the target effect fusion model into a rendering engine, to enable the rendering engine to render a target image corresponding to the to-be-processed image based on the pixel depth information, wherein the target image comprises the target effect.

According to one or more embodiments of the present disclosure, Example 2 provides an effect image processing method, and the method further includes:
determining an effect fusion model corresponding to the target effect as the to-be-processed effect fusion model, according to an effect display shape of the target effect and an effect display area of the target effect.

According to one or more embodiments of the present disclosure, Example 3 provides an effect image processing method, and the method further includes:
in response to receiving the target effect display instruction, displaying the to-be-processed effect fusion model, in which a paper model in the to-be-processed effect fusion model is displayed transparently.

According to one or more embodiments of the present disclosure, Example 4 provides an effect image processing method, and the method further includes:
determining the human body segmentation region in the to-be-processed image corresponding to the target object; and
binding the human body segmentation region with the to-be-processed effect fusion model to obtain the target effect fusion model.

According to one or more embodiments of the present disclosure, Example 5 provides an effect image processing method, and the method further includes:
determining the human body segmentation region in the to-be-processed image based on a human body segmentation algorithm or a human body segmentation model.

According to one or more embodiments of the present disclosure, Example 6 provides an effect image processing method, and the method further includes:
the human body segmentation region is an area in a torso segmentation region.

According to one or more embodiments of the present disclosure, Example 7 provides an effect image processing method, and the method further includes:
binding the human body segmentation region with the to-be-processed effect fusion model to obtain a to-be-used effect fusion model; and
performing intersection processing on the human body segmentation region and the to-be-used effect fusion model to determine the target effect fusion model.

According to one or more embodiments of the present disclosure, Example 8 provides an effect image processing method, and the method further includes:
determining a target reference axis corresponding to the target object; and
using the target reference axis to control the human body segmentation region and the to-be-processed effect fusion model to move together, to obtain the to-be-used effect fusion model.

According to one or more embodiments of the present disclosure, Example 9 provides an effect image processing method, and the method further includes:
determining, based on a rendering camera, pixel depth information of a plurality of pixels corresponding to the target effect fusion model, and writing, based on the rendering engine, the pixel depth information into the rendering engine, to write the pixel depth information into a paper model in the to-be-processed effect fusion model to obtain the target image.

According to one or more embodiments of the present disclosure, Example 10 provides an effect image processing method, and the method further includes:
in response to the target effect display instruction being not received again and the to-be-processed image being acquired again, determining the target effect fusion model based on binding of the to-be-processed effect fusion model with the human body segmentation region.

According to one or more embodiments of the present disclosure, Example 11 provides an effect image processing apparatus, and the apparatus includes:
a to-be-processed effect fusion model determination module, configured to determine a to-be-processed effect fusion model according to an effect attribute of a target effect to be overlaid;
a target effect fusion model determination module, configured to, in response to receiving a target effect display instruction, determine a target effect fusion model according to the to-be-processed effect fusion model and a human body segmentation region in a to-be-processed image corresponding to a target object; and
a rendering module, configured to write pixel depth information corresponding to the target effect fusion model into a rendering engine, to enable the rendering engine to render a target image corresponding to the to-be-processed image based on the pixel depth information, in which the target image includes the target effect.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment.

Conversely, various features that are described in the context of a single embodiment may also be implemented in multiple embodiments separately or in any suitable sub-combinations.

1. An effect image processing method, comprising:
determining a to-be-processed effect fusion model according to an effect attribute of a target effect to be overlaid;
in response to receiving a target effect display instruction, determining a target effect fusion model according to the to-be-processed effect fusion model and a human body segmentation region in a to-be-processed image corresponding to a target object; and
writing pixel depth information corresponding to the target effect fusion model into a rendering engine, to enable the rendering engine to render a target image corresponding to the to-be-processed image based on the pixel depth information, wherein the target image comprises the target effect.

2. The method according to claim 1, wherein the determining the to-be-processed effect fusion model according to the effect attribute of the target effect to be overlaid, comprises:
determining an effect fusion model corresponding to the target effect as the to-be-processed effect fusion model, according to an effect display shape of the target effect and an effect display area of the target effect.

3. The method according to claim 1, further comprising:
in response to receiving the target effect display instruction, displaying the to-be-processed effect fusion model, wherein a paper model in the to-be-processed effect fusion model is displayed transparently.

4. The method according to claim 1, wherein the determining the target effect fusion model according to the to-be-processed effect fusion model and the human body segmentation region in the to-be-processed image corresponding to the target object, comprises:
determining the human body segmentation region in the to-be-processed image corresponding to the target object; and
binding the human body segmentation region with the to-be-processed effect fusion model to obtain the target effect fusion model.

5. The method according to claim 4, wherein the determining the human body segmentation region in the to-be-processed image corresponding to the target object, comprises:
determining the human body segmentation region in the to-be-processed image based on a human body segmentation algorithm or a human body segmentation model.

6. The method according to claim 5, wherein the human body segmentation region is an area in a torso segmentation region.

7. The method according to claim 4, wherein the binding the human body segmentation region with the to-be-processed effect fusion model to obtain the target effect fusion model, comprises:
binding the human body segmentation region with the to-be-processed effect fusion model to obtain a to-be-used effect fusion model; and
performing intersection processing on the human body segmentation region and the to-be-used effect fusion model to determine the target effect fusion model.

8. The method according to claim 7, wherein the binding the human body segmentation region with the to-be-processed effect fusion model to obtain a to-be-used effect fusion model, comprises:
determining a target reference axis corresponding to the target object; and
using the target reference axis to control the human body segmentation region and the to-be-processed effect fusion model to move together, to obtain the to-be-used effect fusion model.

9. The method according to claim 1, wherein the writing pixel depth information corresponding to the target effect fusion model into the rendering engine, to enable the rendering engine to render the target image corresponding to the to-be-processed image based on the pixel depth information, comprises:
determining, based on a rendering camera, pixel depth information of a plurality of pixels corresponding to the target effect fusion model, and
writing, based on the rendering engine, the pixel depth information into the rendering engine, to write the pixel depth information into a paper model in the to-be-processed effect fusion model to obtain the target image.

10. The method according to claim 1, further comprising:
in response to the target effect display instruction being not received again and the to-be-processed image being acquired again, determining the target effect fusion model based on binding of the to-be-processed effect fusion model with the human body segmentation region.

11. (canceled)

12. An electronic device, comprising:
at least one processor; and
a storage apparatus, configured to store at least one program,
wherein the at least one program, when executed by the at least one processor, enables the at least one processor to implement an effect image processing method, and the effect image processing method comprises:
determining a to-be-processed effect fusion model according to an effect attribute of a target effect to be overlaid;
in response to receiving a target effect display instruction, determining a target effect fusion model according to the to-be-processed effect fusion model and a human body segmentation region in a to-be-processed image corresponding to a target object; and
writing pixel depth information corresponding to the target effect fusion model into a rendering engine, to enable the rendering engine to render a target image corresponding to the to-be-processed image based on the pixel depth information, wherein the target image comprises the target effect.

13. A non-transitory storage medium, comprising computer-executable instructions, wherein the computer-executable instructions, when executed by a computer processor, are configured to perform an effect image processing method, and the effect image processing method comprises:
determining a to-be-processed effect fusion model according to an effect attribute of a target effect to be overlaid;
in response to receiving a target effect display instruction, determining a target effect fusion model according to the to-be-processed effect fusion model and a human body segmentation region in a to-be-processed image corresponding to a target object; and
writing pixel depth information corresponding to the target effect fusion model into a rendering engine, to enable the rendering engine to render a target image corresponding to the to-be-processed image based on the pixel depth information, wherein the target image comprises the target effect.

14. (canceled)

15. The electronic device according to claim 12, the determining the to-be-processed effect fusion model according to the effect attribute of the target effect to be overlaid, comprises:
determining an effect fusion model corresponding to the target effect as the to-be-processed effect fusion model, according to an effect display shape of the target effect and an effect display area of the target effect.

16. The electronic device according to claim 12, wherein the effect image processing method further comprises:
in response to receiving the target effect display instruction, displaying the to-be-processed effect fusion model, wherein a paper model in the to-be-processed effect fusion model is displayed transparently.

17. The electronic device according to claim 12, wherein the determining the target effect fusion model according to the to-be-processed effect fusion model and the human body segmentation region in the to-be-processed image corresponding to the target object, comprises:
determining the human body segmentation region in the to-be-processed image corresponding to the target object; and
binding the human body segmentation region with the to-be-processed effect fusion model to obtain the target effect fusion model.

18. The electronic device according to claim 17, wherein the determining the human body segmentation region in the to-be-processed image corresponding to the target object, comprises:
determining the human body segmentation region in the to-be-processed image based on a human body segmentation algorithm or a human body segmentation model.

19. The electronic device according to claim 18, wherein the human body segmentation region is an area in a torso segmentation region.

20. The electronic device according to claim 17, wherein the binding the human body segmentation region with the to-be-processed effect fusion model to obtain the target effect fusion model, comprises:
binding the human body segmentation region with the to-be-processed effect fusion model to obtain a to-be-used effect fusion model; and
performing intersection processing on the human body segmentation region and the to-be-used effect fusion model to determine the target effect fusion model.

21. The electronic device according to claim 20, wherein the binding the human body segmentation region with the to-be-processed effect fusion model to obtain a to-be-used effect fusion model, comprises:
determining a target reference axis corresponding to the target object; and
using the target reference axis to control the human body segmentation region and the to-be-processed effect fusion model to move together, to obtain the to-be-used effect fusion model.

22. The electronic device according to claim 12, wherein the writing pixel depth information corresponding to the target effect fusion model into the rendering engine, to enable the rendering engine to render the target image corresponding to the to-be-processed image based on the pixel depth information, comprises:
determining, based on a rendering camera, pixel depth information of a plurality of pixels corresponding to the target effect fusion model, and
writing, based on the rendering engine, the pixel depth information into the rendering engine, to write the pixel depth information into a paper model in the to-be-processed effect fusion model to obtain the target image.
